(19) United States
(12) Patent Application Publication
(10) Pub. No.: US 2026/0309281 A1
(43) Pub. Date: Oct. 8, 2026

(54) Inflating Device

(71) Applicant: Zafrir TOMER, Kiryat Ata (IL)

(72) Inventor: Zafrir TOMER, Kiryat Ata (IL)

(21) Appl. No.: 19/478,976

(22) PCT Filed: Apr. 28, 2024
(86) PCT No.: PCT/IL2024/050407

§ 371 Date: Oct. 27, 2025

Related U.S. Application Data
(60) Provisional application No. 63/462,260, filed on Apr. 27, 2023.

(51) Int. Cl. F17C 13/04

(52) U.S. Cl. CPC F17C 13/04; F17C 2201/0109; F17C 2201/058; F17C 2205/032; F17C 2205/0323; F17C 2205/0382; F17C 2221/031; F17C 2223/0123; F17C 2270/0736

(57) ABSTRACT

An inflating device (10) comprising an activating sleeve (12), having a longitudinal axis (A), that is positioned within a rear opening (42) of a main body (38); a cartridge (16), having a sealed cartridge front end (98), is filled with pressurized gas and is placed within a cutout (24) of a front section (14) of the activating sleeve (16); an operating valve (40) comprising a release needle (92) that is directed toward the cartridge front end (98) is formed within the main body (38); and, rotation of the activating sleeve (12) at an operating rotation angle around the longitudinal axis (A) induces a forward translational movement of the activating sleeve (12) with respect to the main body (38) in a direction parallel to the longitudinal axis (A), pressing the cartridge front end (98) against the release needle (92), and releasing the pressurized gas into the operating valve (40). During the rotation of the activating sleeve (12), the cartridge (16) is gradually covered by the front section (14) of the activating sleeve (12).

### CROSS-REFERENCE TO RELATED APPLICATIONS

This application claims priority from U.S. Provisional Patent Application No. 63/462,260, filed Apr. 27, 2023, whose disclosure is incorporated by reference in its entirety herein.

### FIELD OF THE INVENTION

The present invention relates to the field of inflating devices, and more particularly to the field of quick inflating devices that inflate inflatable objects by means of a pressurized cartridge.

### BACKGROUND OF THE INVENTION

Inflating devices that use a pressurized cartridge are known. A sample use for such devices is when using a pressurized cartridge containing pressurized CO2. The CO2 is inserted into a bottle containing water for receiving a blend of sparkling water. Another example is when using a pressurized cartridge containing pressurized air for inflating an inflatable device such as a ball or a bicycle tube.

Such devices include a pressurized cartridge or cylinder, typically refillable, filled with a pressurized gas, wherein the cartridge is inserted into an insertion chamber of a cartridge holder. The cartridge holder has a threaded portion in a front portion thereof. The threaded portion is an internal thread or an external thread that engages into a mating threaded portion of a distribution valve. By turning the cartridge holder such that its threaded portion threadingly engages into the threaded portion of the distribution valve, the cartridge is forcibly inserted into the distribution valve until a release needle of the distribution valve is pressed onto a release valve of the cartridge and the release valve is open. At this stage, the pressurized gas within the cartridge is freely released, through the distribution valve, into a device which receives the pressurized gas, like a bottle or an inflatable device.

In some devices, the pressurized gas within the cartridge is not freely released, but, an operating handle has to be operated. The operating handle can be of a kind used in a globe valve, i.e., the handle has to be rotated several rounds in order to open a passage for the released gas. In other devices, the distribution valve is of a ball valve type, and, in order to operate the ball valve an operating handle has to be rotated 180-degrees for fully opening the passage for the released gas.

A drawback of such devices is that the turning of the cartridge holder into/onto the distribution valve requires, relatively, a lot of time and effort.

Other kind of devices do not use a cartridge holder. In this kind of devices, the cartridge is provided with a threaded front portion that is directly threadingly engaged into a threaded portion of a distribution valve. In addition to the drawbacks of time consuming and the required effort, this kind of devices require to put a thermal sleeve on the cartridge in order to prevent getting cold-burns due to the drastic temperature drop of the cartridge during its emptying through the distribution valve.

In other kind of devices, instead of putting a thermal sleeve on the cartridge, a cover cylinder, having a front threaded portion, is threadingly engaged into/onto a corresponding thread at the distribution valve, around the cartridge that is already threadingly engaged into the distribution valve. Such a device requires, of course, two separate threads, and more time to thread into them.

### SUMMARY OF THE INVENTION

The present invention is an inflating device for inflating inflatable objects by means of a pressurized cartridge filled with compressed air.

According to embodiments of the present invention there is provided an inflating device comprising an activating sleeve, having a longitudinal axis, that is positioned within a rear opening of a main body,
a cartridge, having a sealed cartridge front end, is filled with pressurized gas and is placed within a cutout of a front section of the activating sleeve,
an operating valve comprising a release needle that is directed toward the cartridge front end is formed within the main body, wherein
rotation of the activating sleeve at an operating rotation angle around the longitudinal axis induces a forward translational movement of the activating sleeve with respect to the main body in a direction parallel to the longitudinal axis, pressing the cartridge front end against the release needle, and releasing the pressurized gas into the operating valve.

Practically, the operating rotation angle is in the range of 90-degrees to 180-degrees.

If desired, the operating rotating angle is 180-degrees.

Practically, the activating sleeve comprises at least one operating groove that extends at a sector of the operating rotation angle,
the main body comprises at least one sleeve fixation pin, and wherein
in an assembled position of the activating sleeve within the main body, the at least one sleeve fixation pin is received within the at least one operating groove, and a movement of the activating sleeve with respect to the main body is limited to a movement of the at least one operating groove on the at least one sleeve fixation pin.

If desired, the activating sleeve comprises an operating handle at a rear end of the activating sleeve.

Further if desired, the operating handle comprises two diametrically opposite arms.

Typically, the activating sleeve has a rear section, located rearwardly with respect to the front section of the activating sleeve, wherein
the front section has a front section thickness, the rear section has a rear section thickness, and wherein
the rear section thickness is larger than the front section thickness.

Further typically, a rear end of the front section of the activating sleeve comprises a semi-peripherally extending and forwardly facing abutment surface for abutting a rear surface of the cartridge.

Practically, the main body comprises a side opening that extends along a major portion of the main body, narrows toward its front portion, and enables easy insertion of the cartridge into the side opening.

Further typically, the operating valve comprises a valve body formed with a sliding cavity for sliding therein an operating knob having a knob longitudinal axis, the valve body comprises an inlet aperture that is colinear with an outlet aperture about an operating valve outlet axis, wherein
the operating knob comprises a hollow aperture that extends through an entire thickness of the operating knob in a direction that is perpendicular to the knob longitudinal axis and parallel to the operating valve outlet axis, and wherein
when the operating knob is in a closed position, a passage between the inlet aperture and the outlet aperture is blocked, and
when the operating knob is in an open position, the hollow aperture is aligned with the inlet aperture and with the outlet aperture.

If desired, the operating knob comprises a valve operating groove into which a valve fixation pin passes therethrough.

Functionally, the valve fixation pin prevents rotation of the operating knob around the knob longitudinal axis.

Further functionally, the valve fixation pin limits the sliding of the operation knob between an uppermost position, being the closed position of the operating valve, and a lowermost position, being the open position of the operating valve.

If desired, the operating knob is constantly urged to the uppermost position by a normally-extended spring that is pressed between a lowermost end of the sliding cavity, and, a knob lowermost end.

Further if desired, the operating knob is urged to the lowermost position by an operating knob handle of the operating knob that is pressed downwardly.

Practically, when the operating knob is urged to the lowermost position by the operating knob handle, the pressurized gas that was released from the cartridge flows through the inlet aperture, through the hollow aperture, through the outlet aperture, and through an outlet of the main body.

Advantageously, during the rotation of the activating sleeve, the cartridge is gradually covered by the front section of the activating sleeve.

Further advantageously, replacement of a used cartridge is carried out by rotation of the activating sleeve in a counter-clockwise direction at the same operating rotation angle that was used for activating the cartridge, and
by turning the inflating device upside down the cartridge falls out of the inflating device by the force of gravity.

Functionally, the counter-clockwise rotation of the activating sleeve results in the following: (1) the cartridge front end is released from its contact with the release needle, (2) the activating sleeve moves rearwardly to an initial un-operated position, and (3) the front section of the activating sleeve uncovers the cartridge.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a perspective view of an activating sleeve according to an embodiment of the present invention;

FIG. 2 is a perspective view of a main body according to an embodiment of the present invention;

FIG. 3 is a perspective view of the activating sleeve of FIG. 1 assembled into the main body of FIG. 2, with a cartridge inserted into the activating sleeve;

FIG. 4 is a perspective view of the activating sleeve and the main body of FIG. 3, with the cartridge in an operating position;

FIG. 5 is a perspective view of an operating valve according to an embodiment of the present invention; and

FIG. 6 is a cross-sectional view of the operating valve of FIG. 5.

### DESCRIPTION OF PREFERRED EMBODIMENTS

The present invention is an inflating device 10 for inflating inflatable objects, particularly, but not limited to, sport balls, such as footballs, basketballs and the like, by means of a pressurized cartridge filled with compressed air, in a fast and efficient manner.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways. Initially, throughout this document, references are made to directions such as, for example, upper and lower, left and right, and the like. These directional references are exemplary only to illustrate the invention and embodiments thereof.

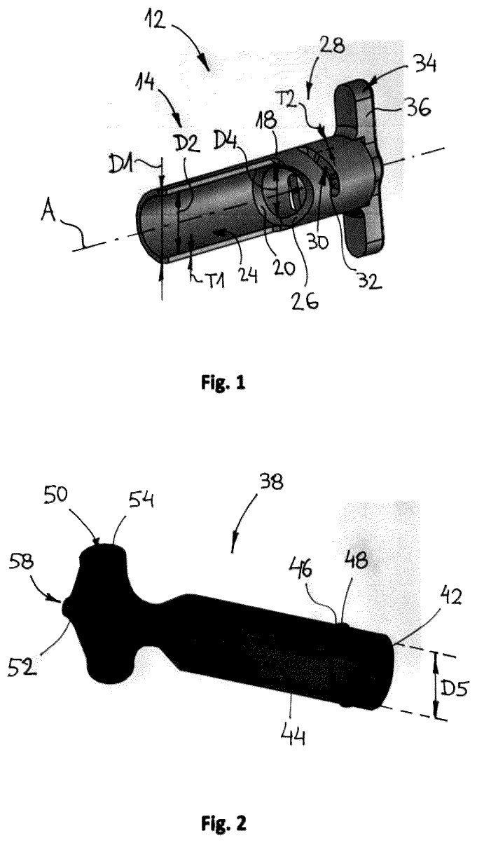

Attention is drawn to FIGS. 1-6. FIG. 1 shows a perspective view of an activating sleeve 12 according to an embodiment of the present invention. The activating sleeve 12 is formed as an elongated tube, having an external diameter D1 and a longitudinal axis A.

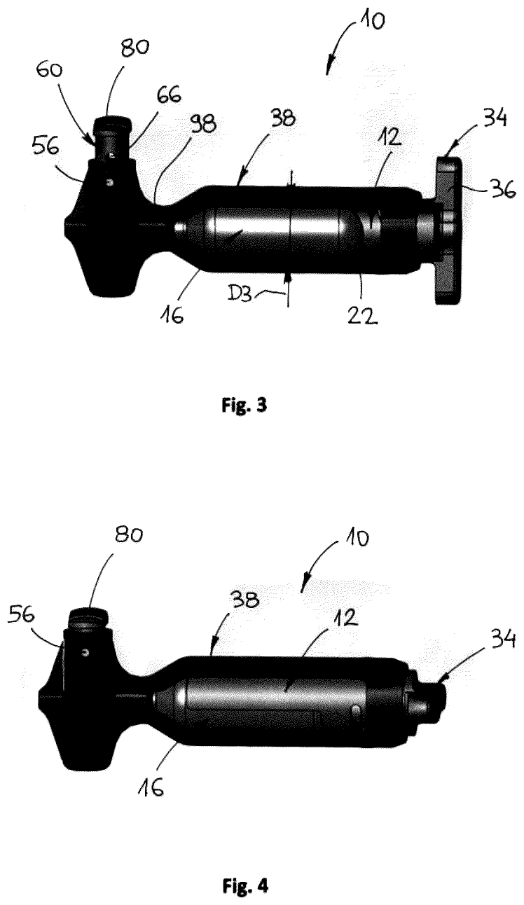

A front section 14 of the activating sleeve 12 is cut-off for enabling a sideways insertion of a cartridge 16 into the activating sleeve 12, as shown in FIG. 3. Thus, the front section 14 of the activating sleeve 12 is formed like a cylinder that is cut by a plane (not shown) that passes through the longitudinal axis A or parallel thereto. The front section 14 of the activating sleeve 12 has the external diameter D1 of the activating sleeve 12, and, an internal diameter D2 that is slightly larger than a cartridge diameter D3. Thus, a front section thickness T1 equals to (D1−D2)/2.

A rear end 18 of the front section 14 comprises a semi-peripherally extending and forwardly facing abutment surface 20 for abutting a rear surface 22 of the cartridge 16 (seen in FIG. 3). The abutment surface 20 is curved such that its curvature conforms with the curvature of the rear surface 22 of the cartridge 16. The rest of the periphery beyond the abutment surface 20 forms a part of a cutout 24 of the front section 14 and extend further rearwardly with respect to the abutment surface 20 in order to provide easy insertion of the cartridge 16 into the activating sleeve 12. A rear end of the cutout 24 ends with a cutout rear surface 26.

The abutment surface 20 has the external diameter D1 of the activating sleeve 12, and, an internal diameter D4 that is smaller than the cartridge diameter D3 for ensuring safe and firm abutment of the rear surface 22 of the cartridge 16 against the abutment surface 20.

A rear section 28 of the activating sleeve 12, located rearwardly with respect to the front section 14 of the activating sleeve 12, has the external diameter D1 of the activating sleeve 12, and, an internal diameter D4 which is congruent to the internal diameter of the abutment surface 20. Thus, a rear section thickness T2 equals to (D1−D4)/2.

The rear section 28 of the activating sleeve 12 is provided with two, diametrically opposite, operating grooves 30, extending to the entire thickness of the rear section 28, i.e., having a thickness that equals to the rear section thickness T2.

Each of the operating grooves 30 extends along a sector, being an operating rotation angle, of 180-degrees with respect to a plane (not shown) that is perpendicular to the longitudinal axis A. Each of the operating grooves 30 is directed such as to conform with a direction of a right-hand thread. A rear end of each operating groove 30 ends with a locking portion 32 that extends perpendicularly to the longitudinal axis A.

A rear end of the rear section 28 ends with an operating handle 34. The operating handle 34 has two, diametrically opposite, arms 36, that enable easy holding and rotation of the activating sleeve 12.

The inflating device 10 further comprises a main body 38 (see FIG. 2) for holding the activating sleeve 12 and an operating valve 40. The main body 38 has a rear opening 42 having a rear opening diameter D5 that is slightly larger than the external diameter D1 of the activating sleeve 12 for enabling insertion of the activating sleeve 12 into the main body 38.

The main body 38 comprises a side opening 44 that extends along a major portion of the main body 38, narrows toward its front portion, and enables easy insertion of the cartridge 16 into the side opening 44.

The main body 38 comprises, at a rear portion thereof, two, diametrically opposite, sleeve pin holes 46 for receiving a sleeve fixation pin 48 in each of the sleeve pin holes 46. The sleeve fixation pins 48 are threadingly engaged into the sleeve pin holes 46, or otherwise connected therein.

The main body comprises, at a front portion thereof, a front cavity 50 for receiving therein the operating valve 40. Two, diametrically opposite, valve pin holes 52 are positioned adjacent to an opening 54 of the front cavity 50. The valve pin holes 52 enable to passing therethrough a valve fixation pin 56 (seen in FIG. 6), for fixing the operating valve 40 into the front cavity 50.

An outlet 58 of the main body 38 is formed at a front end of the main body 38. The outlet 58 is typically formed with a thread (not shown) for threadingly engaging with an inflating connector. Typically, the inflating connector is an air inflation needle for being inserted into an inflatable ball that has to be inflated, or, a tire inflator extension that connects onto a tube valve of a bicycle or the like.

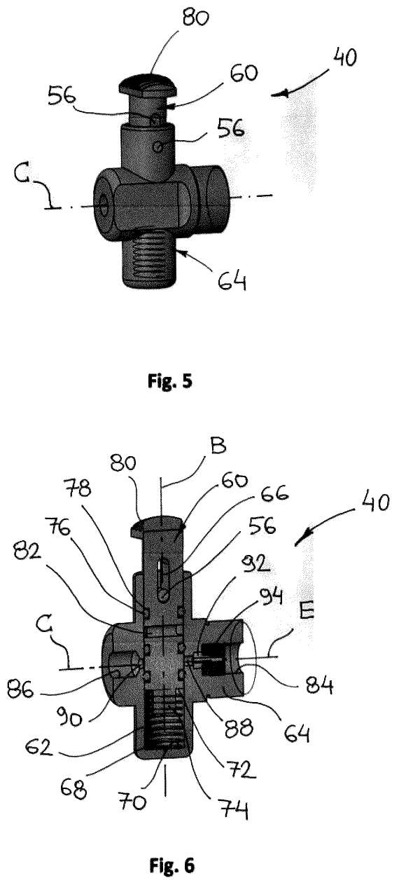

Before a pressurized cartridge is inserted into the activating sleeve 12, the inflating device 10 has to be assembled. Thus, the activating sleeve 12 is inserted through the rear opening 42 of the main body 38 until the operating grooves 30 of the activating sleeve 12 are opposite the sleeve pin holes 46 of the main body 38. At this stage, a sleeve fixation pin 48 is inserted through each of the sleeve pin holes 46 for engaging into an operating groove 30 of the activating sleeve 12, so that the activating sleeve 12 is engaged within the main body 38. The construction of the operating valve 40, as shown in FIGS. 5 and 6, will now be described. The operating valve 40 comprises an elongated operating knob 60, having a knob longitudinal axis B, that slides lengthwise within a sliding cavity 62. The sliding cavity 62 is formed within a valve body 64. The operating knob 60 comprises, in an upper section thereof, a valve operating groove 66 into which the valve fixation pin 56 passes therethrough.

The valve fixation pin 56 serves two purposes. First, it prevents rotation of the operating knob 60 around the knob longitudinal axis B. Second, it limits the slide of the operating knob 60 between two extreme positions; a closed position of the operating valve 40 (as shown in FIG. 6), when the operating valve 40 is in its uppermost position, and, an open position of the operating valve 40, when the operating valve 40 is in its lowermost position. The operating knob 60 is constantly urged to an uppermost position by means of a normally-extended spring 68 that is pressed between a lowermost end 70 of the sliding cavity 62, and, a knob lowermost end 72. The knob lowermost end 72 comprises a downwardly extending guiding protrusion 74 for guiding the spring 68 parallel to the knob longitudinal axis B.

The operating knob 60 further comprises three sealing O-rings 76, located lengthwise along the operating knob 60 within corresponding ring grooves 78 for providing airtight sealing between the operating knob 60 and the valve body 64. An operating knob handle 80 is formed at an uppermost end of the operating knob 60, and is operated by pressing downwards the operating knob handle 80.

The operating knob 60 comprises, in a central portion thereof, a hollow aperture 82 that extends through the entire thickness of the operating knob 60 in a direction that is perpendicular to the knob longitudinal axis B and parallel to an operating valve outlet axis C.

The valve body 64 comprises an inlet cavity 84 and an outlet cavity 86 that are coaxial with the operating valve outlet axis C. The inlet cavity 84 opens into the sliding cavity 62 by an inlet aperture 88, and, the outlet cavity 86 opens into the sliding cavity 62 by an outlet aperture 90.

A release needle 92 is located within the inlet cavity 84. The release needle 92 is pointing toward the cartridge 16 that is located within the activating sleeve 12, and is held by a generally cylindrically shaped seal 94.

The release needle 92 has a needle longitudinal axis E that is coaxial with the operating valve outlet axis C, and, a through needle bore 96 that is coaxial with the needle longitudinal axis E. A forward end of the release needle 92 is formed like a truncated cone having a front surface that is directed perpendicularly to the needle longitudinal axis E.

The operation of the inflating device 10 will now be described. When the activating sleeve 12 is engaged within the main body 38, the activating sleeve 12 is limited to the movement of an operating groove 30 onto its corresponding sleeve fixation pin 48. The movement of the activating sleeve 12 with respect to the main body 38 is carried out by the operating handle 34.

At a non-operative position of the activating sleeve 12, as shown in FIG. 3, the activating sleeve 12 is in its rearmost position with respect to the main body 38. When it is required to use the inflating device 10 for inflating an inflatable device, e.g., a football, first, an air inflating needle (not shown) is threaded into the outlet 58 of the main body 38, and then, the air inflating needle is inserted into an inflating aperture of the football.

Next, a pressurized cartridge 16 filled with compressed air in inserted into the side opening 44 of the main body 38 and into the activating sleeve 12 such that a cartridge front end 98 faces forwardly and toward the operating valve 40.

At the next stage, the operating handle 34 is rotated 180-degrees clockwise, by means of its arms 36, thus rotating the activating sleeve 12 180-degrees clockwise. Such a rotation of the activating sleeve 12 results in the following: (1) the operating grooves 30 of the activating sleeve 12 are forced to remain over the sleeve fixation pins 48. (2) due to the fixed position of the sleeve fixation pins 48, the activating sleeve 12 is forced to move forward a translational movement. (3) during the gradual turning of the activating sleeve 12, the cartridge 16 is gradually covered by the front section 14 of the activating sleeve 12, thus preventing the cartridge 16 from being exposed during its emptying, preventing the need to cover the cartridge with a thermal cover, and preventing the possibility of getting cold-burns during the emptying of the cartridge 16. (4) at a final stage of the forward movement of the activating sleeve 12, the cartridge front end 98 is pressed against a front end of the release needle 92, the cartridge front end 98 is open to passage of gas, either by operation of a release valve of the cartridge or by tearing-off a sealing plug of the cartridge, and the released gas flows into the operating valve 40.

Now, in order to enable the passage of the compressed gas into the ball, the operating knob handle 80 is pressed up to the end of its stroke. The downward movement of the valve body 64 causes the hollow aperture 82 of the valve body 64 to be aligned with the inlet aperture 88 of the inlet cavity 84, the outlet aperture 90 of the outlet cavity 86 and coaxial with the operating valve outlet axis C. In this position, the pressurized gas that entered into the inlet aperture 88 of the operating valve 40 could now keep flowing, through the hollow aperture 82, the outlet aperture 90, and the outlet 58 of the main body 38 of the inflating device 10, and through the air inflating needle into the ball.

When the operating handle 34 is rotated 180-degrees from a non-operating position into an operating position, at the end of the rotation the sleeve fixation pins 48 reach to a rear end of the operating grooves 30 and are abutting the locking portions 32 of the operating grooves 30. Since the locking portions extend perpendicularly to the longitudinal axis A, they do not exert any rotational moment on the activating sleeve 12 that may cause the activating sleeve 12 to move axially rearwardly with respect to the release needle 92. Thus, in this manner, the position of the operating handle is locked with respect to the release needle 92 thus ensuring that all the pressurized air within the cartridge 16 will pass through the needle bore 96 without a concern that the activating sleeve 12 will move axially rearwardly, and, without the need to hold tight the main body 38 or the activating sleeve 12 of the inflating device 10.

Another advantage of the inflating device 10 according to embodiments of the present invention it that the release of the used cartridge 16 is very easy in comparing with devices of the prior art that require an un-threading operation, either of a thread of a front portion of the cartridge, or, a thread of an activating device in which the cartridge is retained within.

Thus, in the inflating device 10 according to embodiments of the present invention, when the cartridge 16 has been emptied from the pressurized air that was within and has to be replaced, then, the operating handle 34 of the activating sleeve 12 is rotated counter-clockwise at the same operating rotation angle that was used for activating the cartridge 16, i.e., a 180-degrees rotation according to the described embodiment. The counter-clockwise rotation results in the following: (1) the cartridge front end 98 is released from its contact with the release needle 92, (2) the activating sleeve 12 moves rearwardly to its initial un-operated position, (3) the front section 14 of the activating sleeve 12 uncovers the cartridge 16. Thus, in this position, the cartridge 16 is not held by the inflating device 10, and it can be ejected out of the inflating device 10 just by turning the inflating device 10 upside down, and then, the cartridge 16 falls out by the force of gravity.

The use of a pressurized cartridge for inflating an inflating device, such as a sport ball is benefitted by embodiments of the present invention. The cartridge that is used for inflating the ball is filled with compressed air up to a predetermined pressure that equals a nominal pressure that is required for inflating the ball. Thus, the ball is inflated to the exact required pressure in a fast, convenient, easy and effective manner.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the present invention has been described to a certain degree of particularity, it should be understood that various alterations and modifications could be made without departing from the spirit or scope of the invention as hereinafter claimed.

For example, the fixation pins do not have to be threadingly engaged into the pin holes and they may be fixed within the holes in any other applicable manner.

The fixation pins do not have to comprise two pins. Alternatively, they may be formed as a single pin that is engaged with the two pin holes.

The main body of the inflating device does not have to be formed from a single piece as described. Alternatively, it may be formed from two separate pieces that are connected together for ease of production. In that manner, the activating sleeve will be engaged with a first body piece, the operating valve will be engaged into a second body piece, and then, the first body piece will be attached to the second body piece.

The present invention is equally applicable for a refillable cartridge and for a non-refillable cartridge.

The present invention is equally applicable for cartridges having a release valve and for cartridges that do not have a release valve, but, their front end is covered with a sealing plug, made of a very thin sheet metal, tin, or the like. In which case, when the cartridge is pressed against a front end of the release needle, the release needle presses/punctures the seal and enables release of the compressed gas within the cartridge.

The front end of the release needle does not have to be formed as a truncated cone wherein the front surface of the truncated cone is planar and directed perpendicularly to a longitudinal axis of the release needle, that is colinear with the operating valve outlet axis. According to some embodiments, the front end of the release needle is formed by a plane that is obliquely disposed with respect to the longitudinal axis of the release needle.

The outlet of the inflating device does not have to be colinear with the longitudinal axis of the activating sleeve. According to some embodiments, the outlet of the inflating device is directed perpendicularly to the longitudinal axis of the activating sleeve.

The inflating device does not have to be used for inflating sport balls only and any other kind of inflatable devices, e.g., tire tubes, inflatable boats, and the like, may be inflated by the inflating device as well. In such cases, instead of connecting an air inflating needle into the outlet of the main body, other kind of connecting adapters may be used.

The cartridges according to the present invention may contain compressed air, compressed CO2, or any other compressed gas that may be required for a specific application. The operating handle do not have to be turned clockwise in order to press the cartridge against the release needle. According to some embodiments, the inflating device is made for being used specifically by a left-handed person. In that case, the operating grooves are formed in an opposite direction, i.e., they follow a left-hand thread, and, in order to press the cartridge against the release needle, the operating handle is turned counter-clockwise.

The operating knob does not have to comprise three O-rings, and other number of O-rings may be equally chosen according to design needs.

The operating grooves do not have to extend along a sector of 180-degrees with respect to a plane that is perpendicular to the longitudinal axis A. According to some embodiments, the operating grooves extend along a sector of 90-degrees. Practically, the operating grooves may be formed to extend along a sector that lies in the range of 90-degrees to 180-degrees.

What is claimed is:

1. An inflating device (10) comprising an activating sleeve (12), having a longitudinal axis (A), that is positioned within a rear opening (42) of a main body (38),
a cartridge (16), having a sealed cartridge front end (98), that is filled with pressurized gas and is placed within a cutout (24) of a front section (14) of the activating sleeve (12),
an operating valve (40) comprising a release needle (92) that is directed toward the cartridge front end (98) and is formed within the main body (38), wherein
rotation of the activating sleeve (12) at an operating rotation angle around the longitudinal axis (A) induces a forward translational movement of the activating sleeve (12) with respect to the main body (38) in a direction parallel to the longitudinal axis (A), pressing the cartridge front end (98) against the release needle (92), and releasing the pressurized gas into the operating valve (40).

2. The inflating device (10) according to claim 1, wherein
the operating rotation angle is in the range of 90-degrees to 180-degrees.

3. The inflating device (10) according to claim 1, wherein
the operating rotating angle is 180-degrees.

4. The inflating device (10) according to claim 1, wherein
the activating sleeve (12) comprises at least one operating groove (30) that extends at a sector of the operating rotation angle,
the main body (38) comprises at least one sleeve fixation pin (48), and wherein
in an assembled position of the activating sleeve (12) within the main body (38), the at least one sleeve fixation pin (48) is received within the at least one operating groove (30), and a movement of the activating sleeve (12) with respect to the main body (38) is limited to a movement of the at least one operating groove (30) on the at least one sleeve fixation pin (48).

5. The inflating device (10) according to claim 1, wherein
the activating sleeve (12) comprises an operating handle (34) at a rear end of the activating sleeve (12).

6. The inflating device (10) according to claim 5, wherein
the operating handle (34) comprises two diametrically opposite arms (36).

7. The inflating device (10) according to claim 1, wherein
the activating sleeve (12) has a rear section (28), located rearwardly with respect to the front section (14) of the activating sleeve (12), wherein
the front section (14) has a front section thickness (T1), the rear section (28) has a rear section thickness (T2), and wherein
the rear section thickness (T2) is larger than the front section thickness (T1).

8. The inflating device (10) according to claim 7, wherein
a rear end (18) of the front section (14) of the activating sleeve (12) comprises a semi-peripherally extending and forwardly facing abutment surface (20) for abutting a rear surface (22) of the cartridge (16).

9. The inflating device (10) according to claim 1, wherein
the main body (38) comprises a side opening (44) that extends along a major portion of the main body (38), narrows toward its front portion, and enables easy insertion of the cartridge (16) into the side opening

10. The inflating device (10) according to claim 1, wherein
the operating valve (40) comprises a valve body (64) formed with a sliding cavity (62) for sliding therein an operating knob (60) having a knob longitudinal axis (B),
the valve body (64) comprises an inlet aperture (88) that is colinear with an outlet aperture (90) about an operating valve outlet axis (C), wherein
the operating knob (60) comprises a hollow aperture (82) that extends through an entire thickness of the operating knob (60) in a direction that is perpendicular to the knob longitudinal axis (B) and parallel to the operating valve outlet axis (C), and wherein
when the operating knob (60) is in a closed position, a passage between the inlet aperture (88) and the outlet aperture (90) is blocked, and
when the operating knob (60) is in an open position, the hollow aperture (82) is aligned with the inlet aperture (88) and with the outlet aperture (90).

11. The inflating device (10) according to claim 10, wherein
the operating knob (60) comprises a valve operating groove (66) into which a valve fixation pin (56) passes therethrough.

12. The inflating device (10) according to claim 11, wherein
the valve fixation pin (56) prevents rotation of the operating knob (60) around the knob longitudinal axis (B).

13. The inflating device (10) according to claim 11, wherein
the valve fixation pin (56) limits the sliding of the operation knob (60) between an uppermost position, being the closed position of the operating valve (40), and a lowermost position, being the open position of the operating valve (40).

14. The inflating device (10) according to claim 13, wherein
the operating knob (60) is constantly urged to the uppermost position by a normally-extended spring (68) that is pressed between a lowermost end (70) of the sliding cavity (62), and, a knob lowermost end (72).

15. The inflating device (10) according to claim 13, wherein
the operating knob (60) is urged to the lowermost position by an operating knob handle (80) of the operating knob (60) that is pressed downwardly.

16. The inflating device (10) according to claim 15, wherein
when the operating knob (60) is urged to the lowermost position by the operating knob handle (80), the pressurized gas that was released from the cartridge (16) flows through the inlet aperture (88), through the hollow aperture (82), through the outlet aperture (90), and through an outlet (58) of the main body (38).

17. The inflating device (10) according to claim 1, wherein
during the rotation of the activating sleeve (12), the cartridge (16) is gradually covered by the front section (14) of the activating sleeve (12).

18. The inflating device (10) according to claim 1, wherein
replacement of a used cartridge (16) is carried out by rotation of the activating sleeve (12) in a counter-clockwise direction at the same operating rotation angle that was used for activating the cartridge (16), and
by turning the inflating device (10) upside down the cartridge (16) falls out of the inflating device (10) by the force of gravity.

19. The inflating device (10) according to claim 18, wherein
the counter-clockwise rotation of the activating sleeve (12) results in the following: (1) the cartridge front end (98) is released from its contact with the release needle (92), (2) the activating sleeve (12) moves rearwardly to an initial un-operated position, and (3) the front section (14) of the activating sleeve (12) uncovers the cartridge (16).
